(19) United States
(12) Patent Application Publication
(10) Pub. No.: US 2014/0197943 A1
(43) Pub. Date: Jul. 17, 2014

(54) On-Board Illuminating Device and Vehicle Having Said Illuminating Device

(71) Applicants: Yi Lin Que, Shanghai (CN); Marc Lünnemann, Munchen (DE)

(72) Inventors: Yi Lin Que, Shanghai (CN); Marc Lünnemann, Munchen (DE)

(21) Appl. No.: 14/151,444

(22) Filed: Jan. 9, 2014

(30) Foreign Application Priority Data
Jan. 17, 2013 (CN) 201320026820.9

(51) Int. Cl. B60Q 1/32; B60Q 1/24

(52) U.S. Cl. CPC B60Q 1/323; B60Q 1/24
USPC 340/471

(57) ABSTRACT

The present invention relates to an on-board illuminating device comprising an illuminating unit and a control unit, wherein the control unit transmits a first control signal to the illuminating unit according to an event inside a vehicle (10) characterizing a preparation action for getting out of the vehicle, and the illuminating unit enters an illuminating state in accordance with the first control signal.

### TECHNICAL FIELD

The present invention relates to an on-board illuminating device and a vehicle having said illuminating device.

### BACKGROUND ART

With rapid development of motor vehicle technology, motor vehicles such as sedans or taxis are in widespread application, and higher and higher requirements are made on vehicle safety technology. However, it shall be reminded of potential traffic danger due to design deficiencies of motor vehicles, including accidents caused by opening of vehicle doors when the driver or passenger of a vehicle gets off. Under such circumstances, the opening of a vehicle door is a sudden event for pedestrians or motor vehicles passing by the vehicle, particularly around the vehicle door, and there is no warning. It results in collision of pedestrians or motor vehicles with the opened vehicle door, which further renders a traffic accident, which may be extremely dangerous.

In a solution of the prior art, it is provided that an illuminating device is arranged in a bottom region on the inner side of a vehicle door, said illuminating device having an illuminating unit and being capable of outputting a predetermined character or image through a pre-opened emergent opening. When the driver opens the vehicle door, said illuminating device projects the character or image on the ground through the emergent opening, so as to form the configured illuminated character or image on a ground area passed by the vehicle door during the opening process. Although a vehicle with such an illuminating device mounted can effectively form on the ground an illuminated area for warning, said illuminated area only appears after the opening of the vehicle door, while during the process from the person within the vehicle are preparing to exit to the opening of the vehicle door, the vehicle still cannot provide a warning or suggestive signal for pedestrians or vehicles around. In addition, the illuminating device of said solution is fused within the main body of a vehicle, in which an effective, flexible and detachable installation way cannot be realized.

In another solution of the prior art, it is provided that a lighting strip is mounted in an edge area of a vehicle door. After the opening of the vehicle door, the lighting strip arranged at the edge of said vehicle door enters an illuminating state. However, in said solution, although the lighting strip can illuminate an area around the vehicle door after the opening of the door, it is still unrealizable to provide enough response time for pedestrians or vehicles around said vehicle before the opening of the door, to avoid their collision with the door.

### SUMMARY OF THE INVENTION

In order to solve the above technical problem, the present invention provides a novel on-board illuminating device, which not only provides an effective illuminating effect for person in a vehicle, but also functions for warning pedestrians and vehicles outside the vehicle.

A first object of the present invention is realized through such an on-board illuminating device, viz. the illuminating device comprises an illuminating unit and a control unit, wherein the control unit transmits a first control signal to the illuminating unit according to an event inside a vehicle characterizing a preparation action for getting out of the vehicle, and the illuminating unit enters an illuminating state in accordance with the first control signal. “Event of preparing for exiting” in the category of the present invention refers to an event characterized by reflecting person behavior change or item state change inside a vehicle, and said event only occurs before the opening of the vehicle door. In other words, exterior outline of the vehicle does not change when said event occurs, for example, the door is not opened. Thus, the illuminating device according to the present invention can advantageously illuminate in due course when the event of preparing for exiting occurs inside the vehicle, and thus e.g. output a warning beam before the opening of a door thereof, so as to avoid collision of pedestrians or vehicles outside the vehicle with the door to be opened. In addition, said beam can also provide enough illuminated area for the behavior of exiting of the person within the vehicle.

In a preferable embodiment according to the present invention, the illuminating unit of the illuminating device is mounted outside the vehicle and includes a receiver for receiving the first control signal. The arrangement of the illuminating unit outside the vehicle is not only advantageous for its maintenance, but also can avoid influence of components of the vehicle on the illuminated area or prevent the components from shielding the illuminated area. By means of the receiver, the illuminating device can timely enter the illuminating state outside the vehicle.

It is preferable that the control unit is mounted inside the vehicle, the illuminating unit and the control unit are in wireless signal connection with each other. Although the illuminating unit and control unit designed in such a manner are structurally separated from each other, the two are still in effective interaction in a form of wireless signal transmission, so that a reliable control over the illuminating unit can be realized through the control unit.

It is preferable that the emergent light from the control unit forms a pre-defined warning pattern on the ground.

It is preferable that the control unit further includes a timer which transmits a second control signal to the illuminating unit at a predetermined time point after the illuminating unit enters the illuminating state, and the illuminating unit enters a non-illuminating state in accordance with the second control signal. The timer can be advantageously mounted or integrated in the control unit. By means of the timer, illuminating time of the illuminating unit can be controlled automatically, without manual configuration or control of the illuminating device performed by a user for the purpose that the illuminating unit stops illuminating. Such a configuration is user-friendly, and can save electric energy for the illuminating unit at a certain degree.

It is preferable that the first control signal and the second control signal transmitted from the control unit to the illuminating unit are wireless signals. It not only avoids potentially complex wirings, but also provides a flexible control mode over the illuminating unit.

It is preferable that the illuminating unit further includes a timer configured as a switch, wherein timer switches the illuminating unit into the non-illuminating state at a predetermined time after the illuminating unit enters the illuminating state. The timer can be advantageously mounted or integrated in the illuminating unit. A time is preset for the timer, and then the timer switches the illuminating unit into the non-illuminating state in accordance with said predetermined time, after the illuminating unit enters the illuminating state. By means of said timer, the switch-state of said illuminating unit can be flexibly controlled, and it is avoided that the illuminating device arranged outside the vehicle illuminates for a long time, so as to provide possibilities for more humanized service and energy-saving.

It is preferable that the control unit further includes a detecting device, and the control unit sends the first control signal, when the detecting device detects the event inside a vehicle characterizing a preparation action for getting out of the vehicle. When the person inside the vehicle are preparing to exit or items inside the vehicle characterize the event of preparing for exiting, viz. just before the opening of the vehicle door, said detecting device transmits said first control signal to the illuminating device, and such a signal is transmitted in a wireless manner. Thus, said illuminating device can perform illuminating function, even before the vehicle door is opened.

In a preferable embodiment, the event inside a vehicle characterizing a preparation action for getting out of the vehicle is an action of person within the vehicle of preparing to exit. Passengers within the vehicle or the driver may have certain actions before getting prepared to exit, such as release of the seat belt.

It is preferable that the control unit is additionally mounted on seat belts of the vehicle, and the control unit identifies the action of releasing the seat belt from a fastened state as the action of the person within the vehicle of preparing to exit. Before exiting, the person inside the vehicle have to release the fastened seat belt at their seats, and said action is identified as an action of preparing to exit, which is taken as a judging basis whether the illuminating device arranged outside the vehicle shall be switched on.

It is preferable that the control unit further includes a circuit board and a projector, the circuit board, the projector and the detecting device being in electrical and signal connection with each other, so as to assure that respective components inside the control unit work in cooperation with other components.

It is preferable that a flexible material in strip is used to manufacture the control unit. A flexible control unit enables flexible installation in a suitable region on a seat belt.

It is preferable on the one hand that the detecting device is configured as pressure sensor and the detecting device is at least partially fixed in the buckle region of the seat belt, so as to judge fastened state of the seat belt according to said pressure sensor. When releasing seat belts, the driver or passengers generally have to press the buckle region of a seat belt, so that the metal plug of the seat belt is released from the slot. During said process, the detecting device fixed in the buckle region is also pressed, which prompts the control unit to output the first control signal.

On the other hand, it is preferable that the detecting device is configured as magnetic detector, and the control unit itself forms a closed annular device, the detecting device surrounding a socket receiving the metal plug of the seat belt. According to the magnetic characteristics of the detecting device, the magnetic field in the detecting device would change, if the metal plug is pulled out from the detecting device that is arranged in a manner of surrounding the metal plug, and the control unit is prompted thereby to output the first control signal.

It is preferable that the control unit further includes two free ends respectively configured as a USB plug and a corresponding port, the USB plug is to be plugged into the corresponding port and a closed magnetic circuit can be produced within the control unit.

It is preferable that the USB plug of the control unit acts as charging port for connection of the control unit with an external power source, if the event inside the vehicle characterizing a preparation action for getting out of the vehicle does not occur. Thus, a convenient way for supplying the control unit with electric energy is provided.

It is preferable that the event inside the vehicle characterizing a preparation action for getting out of the vehicle is the flipping of the taximeter board of the vehicle. The vehicle is here for example a taxi, inside which a taximeter board is arranged. Whether a control signal is provided for the illuminating unit so as to start the illuminating function is determined upon the detection whether the taximeter board is flipped down, so that enough response time is provided for pedestrians or vehicles outside the vehicle, before the passenger exiting opens the door.

It is preferable that the illuminating unit is mounted below the vehicle and a light emergent opening of the illuminating unit is directed towards a predetermined illuminated area. In such a manner, said illuminating unit provides directional and targeted illumination.

It is preferable that the illuminating unit is specifically mounted below a door of the vehicle, and the predetermined illuminated area is just a region passed by the door during the opening process. Pedestrians or vehicles outside said vehicle that are going to pass through said region are warned by illumination of said passed area, so that they can go forward by bypassing said region.

It is preferable that the illuminating unit further includes a housing with the light emergent opening, a light emitting module and a power line, wherein the light emitting module positioned in the housing and the receiver are in signal connection with each other, and the power line passes through the housing and electrically connects the light emitting module with the power source of the vehicle.

It is preferable that the illuminating unit further includes a filter grid mounted on the light emergent opening of the illuminating unit, and emergent light of the light emitting module passes through the filter grid and forms a predetermined pattern in the predetermined illuminated area. Said predetermined pattern has a large enough area and a strong enough brightness, so as to warn or notify pedestrians or vehicles outside the vehicle, so that they have a response time that is long enough to avoid collision with the door to be opened.

In addition, the present invention provides a vehicle, which has an illuminating device according to the above description mounted. In such a manner, there are a control unit inside said vehicle, and an illuminating unit controlled by said control unit outside and below said vehicle. The vehicle having the illuminating device of such a type enables effective and flexible control over the illuminating unit arranged outside the vehicle to perform illumination, before the person inside the vehicle leave their seats and open the doors, so that a long enough response time is provided for pedestrians or other vehicles outside the vehicle that are going to pass by the vehicle, and an effective warning effect is realized.

### BRIEF DESCRIPTION OF THE DRAWINGS

The accompanying drawings constitute a part of the present Description and are used to provide further understanding of the present invention. Such accompanying drawings illustrate the embodiments of the present invention and are used to describe the principles of the present invention together with the Description. In the accompanying drawings the same components are represented by the same reference numbers. As shown in the drawings:

FIG. 1 shows a schematic diagram according to the present invention;

FIG. 2 shows a control unit according to a first embodiment of the present invention;

FIG. 3 shows a control unit according to a second embodiment of the present invention;

FIG. 4 shows a control unit according to a third embodiment of the present invention;

FIG. 5 shows an illuminating unit according to the present invention; and

FIG. 6 shows a vehicle according to the present invention.

### DETAILED DESCRIPTION OF THE EMBODIMENTS

The on-board illuminating device according to the present invention comprises an illuminating unit 1 and a control unit 2, wherein said control unit 2 transmits a first control signal S1 to the illuminating unit 1 according to an event inside a vehicle 10 characterizing a preparation action for getting out of the vehicle, viz. when the person inside the vehicle are preparing to exit and before the opening of the doors, and the illuminating unit 1 enters an illuminating state in accordance with the first control signal S1.

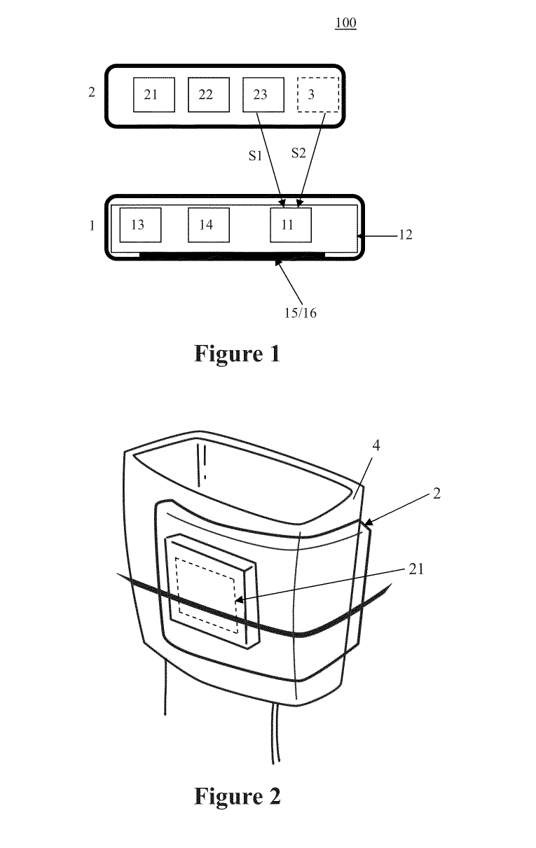

FIG. 1 shows a schematic diagram according to the present invention. As shown in FIG. 1, the control unit 2 is mounted inside the vehicle (not shown), and the illuminating unit 1 including a receiver 11 is mounted outside the vehicle, the illuminating unit 1 and the control unit 2 being in wireless signal connection with each other. A detecting device 21 arranged in the control unit 2 is configured to detect the event inside the vehicle 10 characterizing a preparation action for getting out of the vehicle. An event of preparing for exiting refers to e.g. the action of the person inside the vehicle being preparing to exit, which occurs before the door of the vehicle is opened. At this moment, the control unit 2 transmits the first control signal S1 in a form of wireless signal, and the illuminating unit 1 enters the illuminating state in accordance with the first control signal S1. After a predetermined time period, a timer 3 that may be mounted in the control unit 2 transmits a second control signal S2 to the illuminating unit 1 in a form of wireless signal, and the illuminating unit 1 is therefore switched into a non-illuminating state. In addition, the functions of other components as shown in FIG. 1 and their connections are further explained according to the following figures and descriptions.

In an unshown embodiment, the timer can also be mounted in the illuminating unit. The timer can exist in a form of switch, which flexibly control the switch-state of said illuminating unit at a predetermined time, and avoids illumination of the illuminating device arranged outside the vehicle for a too long time, so as to provide possibilities for more humanized service and energy saving.

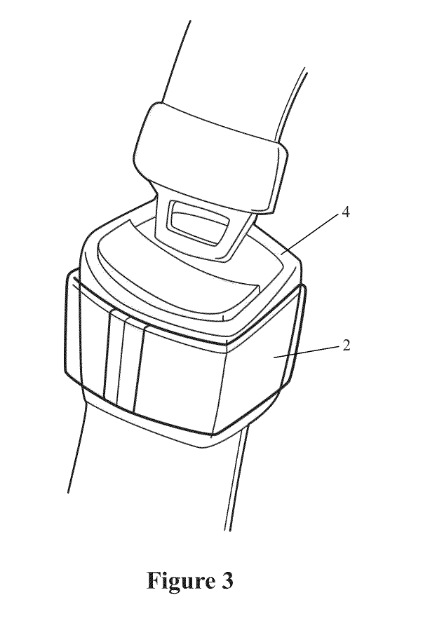

FIG. 2 shows a control unit 2 according to a first embodiment of the present invention. As shown in FIG. 2, the control unit 2 mounted in the buckle region of a seat belt 4 is particularly configured for use in private cars. The control unit 2 is preferably made of a flexible material in strip, which is convenient for additional installation of said control unit 2 on the seat belt 4. For example, a binding material can be preferably used to fix the control unit 2 in the buckle region of the seat belt 4. Other suitable fixing ways may also be considered to realize a fixed connection between the control unit 2 and the seat belt 4.

In addition, said control unit 2 includes a circuit board 22 and a projector 23, and said control unit 2 further has a detecting device 21 configured as pressure sensor, which exists at least partially in a form of pressing button. The circuit board 22, the projector 23 and the detecting device 21 are in electrical and signal connection with each other, and said detecting device 21 is at least partially fixed in the buckle region of the seat belt 4, wherein, as shown in FIG. 2, the area formed by dashed line is a pressing area of the pressure sensor in accordance to the pressing button on the buckle. In such a manner, the fastened state of the seat belt 4 is detected through the pressure sensor, and the action of releasing said seat belt 4 from a fastened state is identified as the action of the person inside the vehicle of preparing to exit, and the control unit 2 can thus transmits the first control signal S1 to the illuminating unit 1 in a form of wireless signal after detection of action change.

FIG. 3 shows a control unit 2 according to a second embodiment of the present invention. The control unit 2 in the present example can also be mounted on the seat belt 4 in the same way as the control unit 2 shown in FIG. 2. In addition, said control unit 2 also includes the circuit board 22 and the projector 23. The difference with respect to the first example lies in that the detecting device 21 of the control unit 2 is configured here as magnetic detector, which is in electrical and signal connection with the circuit board 22 and the projector 23. The flexible control unit 2 with a strip contour per se can form a closed annular device, and said detecting device 21 can surround a socket receiving the metal plug of the seat belt 4. As the detecting device 21 surrounds the socket of the seat belt 4, the action of releasing the seat belt 4 from the fastened state can be detected, viz. magnetic change in the detecting device 21 during the completing period of said action is detected. Thus, said action is identified as action of the person within the vehicle of preparing to exit. The projector 23 of the control unit 2 transmits the first control signal S1 to the illuminating unit 1 in a form of wireless signal in accordance with the detection result, before the vehicle door is opened. In addition, the control unit 2 according to said second example further has two free ends respectively configured as a USB plug and a corresponding port, the USB plug is to be plugged into the corresponding port and a closed magnetic circuit is produced within the control unit 2. The USB plug can also be used as charging port of the control unit 2 during e.g. driving or parking of the vehicle so as for connection with an external power source.

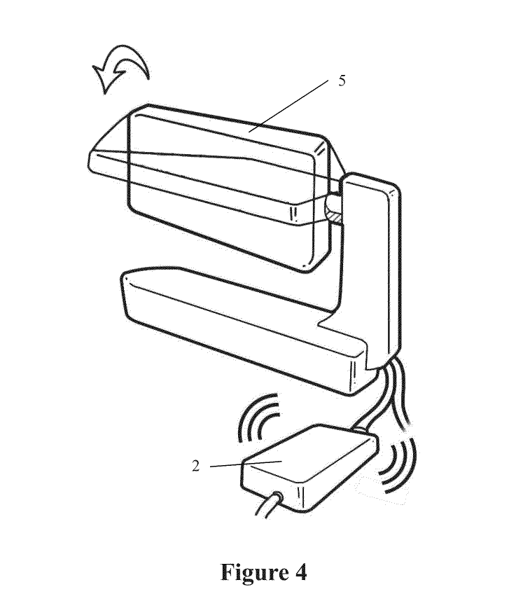

FIG. 4 shows a control unit 2 according to a third embodiment of the present invention. The difference with respect to examples as shown in FIG. 2 and in FIG. 3 lies in that said control unit 2 is configured for use in vehicles with a taximeter board 5, such as taxis. Under such a circumstance, the flipping of the taximeter board 5 can characterize the event of preparing for exiting occurring inside the vehicle 10. In the present example, the control unit 2 also includes the circuit board 22, the projector 23 and the detecting device 21, wherein the detecting device 21 is in connection with the taximeter board 5 as a sensor to identify the flipping of said taximeter board 5. In this case, control over the on-or-off state of illumination of the illuminating unit 1 arranged outside the vehicle 10 can be realized, before the person within the vehicle 10 open the door. Thus, enough response time can be provided for pedestrians or other vehicles outside the vehicle 10 in advance, so as to avoid the possibility that they collide with the doors of said vehicle 10.

In addition, in FIGS. 1, 2, and 3, the control unit 2 according to the first, second and third embodiments of the present invention further includes a timer 3, for which a predetermined time, e.g. after 30 seconds, is set. In this case, the timer 3 transmits the second control signal S2 to the illuminating unit 1 in a form of wireless signal at the predetermined time after the illuminating unit 1 enters the illuminating state, and the illuminating unit 1 enters the non-illuminating state in accordance with the second control signal S2.

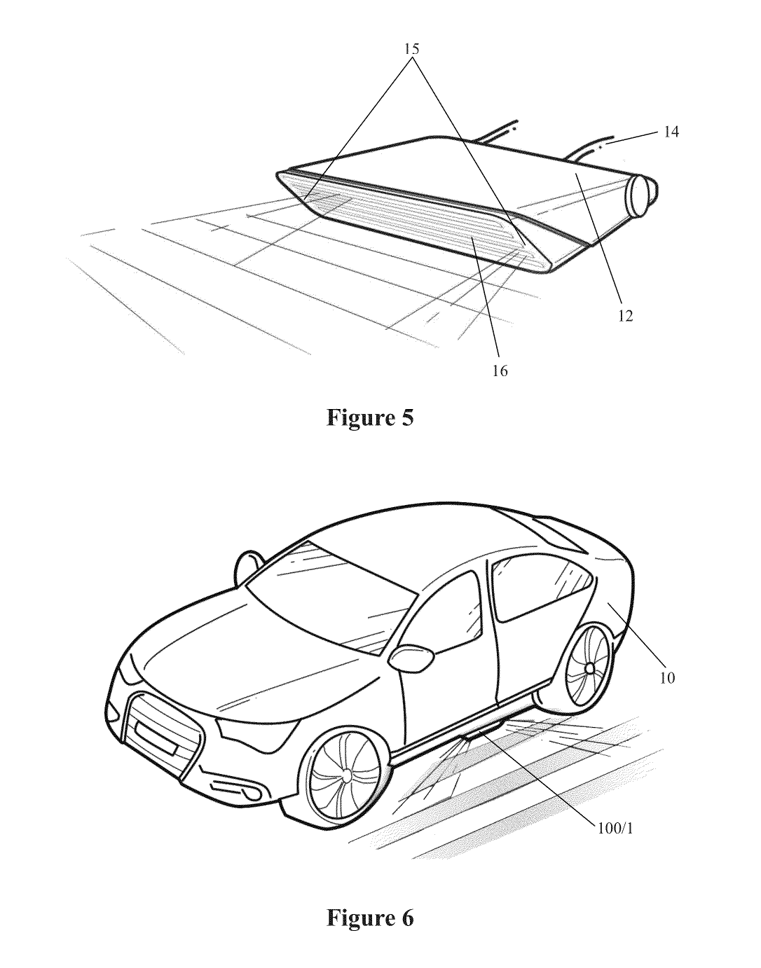

FIG. 5 shows an illuminating unit 1 according to the present invention. As shown in FIG. 5, the illuminating unit 1 includes a housing 12 with a light emergent opening 15, a light emitting module 13, a power line 14 and a receiver 11 for receiving the first control signal S1 from the control unit 2 (see FIGS. 1-4), wherein the light emitting module 13 positioned in the housing 12 and the receiver 11 are in signal connection with each other, and the power line 14 passes through the housing 12 and electrically connects the light emitting module 13 with the power source of the vehicle 10, and the illuminating unit 1 is mounted outside the vehicle 10. In a preferable situation, the illuminating unit 1 is mounted below a door of the vehicle 10, and the light emergent opening 15 of the illuminating unit 1 is directed towards a predetermined illuminated area, which is a region passed by the door during the opening process. The illuminating unit 1 further includes a filter grid 16 mounted on the light emergent opening 15, and emergent light of the light emitting module 13 passes through the filter grid 16 and forms a predetermined pattern in the predetermined illuminated area. Said predetermined pattern can be preferably a pattern such as zebra crossing, which can warn pedestrians or vehicles passing by in a more perceivable manner.

FIG. 6 shows a vehicle according to the present invention. As schematically shown in FIG. 6, said vehicle 10 has an illuminating device 100 according to the above description mounted. In this case, there are a control unit 2 inside said vehicle 10 and an illuminating unit 1 controlled by said control unit 2 outside and below said vehicle 10. The vehicle 10 having the illuminating device 100 of such a type enables timely and flexible control over the illuminating unit 1 arranged outside the vehicle 10 to perform illumination, before the person inside the vehicle leave their seats and open the doors, so that a long enough response time is provided for pedestrians or other vehicles outside the vehicle 10 that are going to pass by the vehicle, and an effective warning effect is realized.

The above is merely preferred embodiments of the present invention but not to limit the present invention. For the person skilled in the art, the present invention may have various alterations and changes. Any alterations, equivalent substitutions, improvements, within the spirit and principle of the present utility model, should be covered in the protection scope of the present utility model.

### LIST OF REFERENCE SIGNS

1 illuminating unit
2 control unit
3 timer
4 seat belt
5 taximeter board
10 vehicle
11 receiver
12 housing
13 light emitting module
14 power line
15 light emergent opening
16 filter grid
21 detecting device
22 circuit board
23 projector
25 USB plug
26 corresponding port
S1 first control signal
S2 second control signal

What is claimed is:

1. An on-board illuminating device comprising an illuminating unit and a control unit, wherein the control unit transmits a first control signal to the illuminating unit according to an event inside a vehicle characterizing a preparation action for getting out of the vehicle, and the illuminating unit enters an illuminating state in accordance with the first control signal.

2. The illuminating device according to claim 1, wherein the illuminating unit is mounted outside the vehicle and includes a receiver for receiving the first control signal.

3. The illuminating device according to claim 1, wherein the control unit is mounted inside the vehicle, the illuminating unit and the control unit are in wireless signal connection with each other.

4. The illuminating device according to claim 1, wherein emergent light of the control unit forms a predetermined warning pattern on the ground.

5. The illuminating device according to claim 4, wherein the control unit further includes a timer which transmits a second control signal to the illuminating unit at a predetermined time after the illuminating unit enters the illuminating state, and the illuminating unit enters a non-illuminating state in accordance with the second control signal.

6. The illuminating device according to claim 5, wherein the first control signal and the second control signal are wireless signals.

7. The illuminating device according to claim 4, wherein the illuminating unit further includes a timer, wherein timer switches the illuminating unit into the non-illuminating state at a predetermined time after the illuminating unit enters the illuminating state.

8. The illuminating device according to claim 5, wherein the control unit further includes a detecting device and the control unit sends the first control signal, when the detecting device detects the event inside the vehicle characterizing a preparation action for getting out of the vehicle.

9. The illuminating device according to claim 8, wherein the event inside the vehicle characterizing a preparation action for getting out of the vehicle is an action of person within the vehicle preparing to exit.

10. The illuminating device according to claim 9, wherein the control unit is additionally mounted on seat belts of the vehicle, and the control unit identifies the action of releasing the seat belt from a fastened state as the action of the person within the vehicle preparing to exit.

11. The illuminating device according to claim 10, wherein the control unit further includes a circuit board and a projector, the circuit board, the projector and the detecting device being in electrical and signal connection with each other.

12. The illuminating device according to claim 11, wherein the control unit is configured to be flexible and in strip.

13. The illuminating device according to claim 12, wherein the detecting device is configured as pressure sensor, and the detecting device is at least partially fixed in the buckle region of the seat belt.

14. The illuminating device according to claim 12, wherein the detecting device is configured as magnetic detector and the control unit itself forms a closed annular device, the detecting device surrounding a socket receiving the metal plug of the seat belt.

15. The illuminating device according to claim 14, wherein the control unit further includes two free ends respectively configured as a USB plug and a corresponding port, the USB plug is to be plugged into the corresponding port and a closed magnetic circuit can be produced within the control unit.

16. The illuminating device according to claim 15, wherein the USB plug acts as charging port for connection of the control unit with an external power source, if the event inside the vehicle characterizing a preparation action for getting out of the vehicle does not occur.

17. The illuminating device according to claim 8, wherein the event inside the vehicle characterizing a preparation action for getting out of the vehicle is the flipping of the taximeter board of the vehicle.

18. The illuminating device according to claim 5, wherein the illuminating unit is mounted below the vehicle and a light emergent opening of the illuminating unit is directed towards a predetermined illuminated area.

19. The illuminating device according to claim 18, wherein the illuminating unit is mounted below a door of the vehicle and the predetermined illuminated area is a region passed by the door during the opening process.

20. The illuminating device according to claim 19, wherein the illuminating unit further includes a housing with the light emergent opening, a light emitting module and a power line, wherein the light emitting module positioned in the housing and the receiver are in signal connection with each other, and the power line passes through the housing and electrically connects the light emitting module with the power source of the vehicle.

21. The illuminating device according to claim 20, wherein the illuminating unit further includes a filter grid mounted on the light emergent opening, and emergent light of the light emitting module passes through the filter grid and forms a predetermined pattern in the predetermined illuminated area.
